(19) United States
(12) Patent Application Publication
(10) Pub. No.: US 2005/0067919 A1
(43) Pub. Date: Mar. 31, 2005

(54) Polymer actuator having a circular unit cell

(76) Inventor: Robert D. Horning, Savage, MN (US)

Correspondence Address: Matthew S. Luxton;Honeywell International, Inc., Law Dept. AB2, 101 Columbia Road, Morristown, NJ, 07962, US

(21) Appl. No.: 10/673,453

(22) Filed: Sep. 30, 2003

(51) Int. Cl. H02N 1/00

(52) U.S. Cl. 310/309

(57) ABSTRACT

A microactuator device having at least a pair of polymeric sheets each having conductive and dielectric films deposited thereon, the polymeric sheets facing each other and bonded together to create at least one cell having a substantially circular shape parallel to a plane in which the polymeric sheets lie, the at least one cell having at least one egress hole to allow a fluid to pass there through when a source of electric potential is applied to the conductive films to cause a portion of the polymeric sheets in the vicinity of a perimeter of the cell to be attracted to one another and thereby cause the cell to retract or collapse upon itself.

This invention was made with Government support under contract no. F30602-98-C-0217 awarded by DARPA. The Government has certain rights in the invention.

### BACKGROUND

1. Field of the Invention

The present invention relates to microactuators having macroscopic force and displacement. More particularly the present invention relates to microactuators having a novel unit cell shape and that are formed from plastic sheets that can be stacked or laminated for stronger actuation.

2. Background of the Invention

Early microelectromechanical system (MEMS) microactuator arrays were typically fabricated in silicon. Despite the many favorable attributes of silicon, however, it is not always a suitable or ideal material for every application of MEMS. For instance, silicon is brittle and subject to breaking, particularly as the total device size increases. This brittleness limits devices, especially actuators, to relatively small sizes capable of only small displacements and forces. The shapes that can be realized in silicon are typically restricted by crystalline planes or 2-D fabrication processes, and more complicated structures often result in prohibitively high cost and low yield.

In an effort to overcome the deficiencies of silicon-based MEMS, microactuators have recently been developed using polymer sheets with integral electrodes that can be energized, causing electrostatic force to be generated and thereby causing the sheets to be attracted to one another. U.S. Pat. No. 6,255,758 to Cabuz et al. describes a polymer microactuator array that includes a plurality of sheets that are layered upon one another. In the embodiment described, every other sheet is flat and sheets disposed between the flat sheets are corrugated resulting in what can be considered a plurality of “linear” unit cells. Large forces are achieved by reducing the unit cell size. Unfortunately, this reduces the displacement as well. To achieve large displacements, many layers of unit cells have to be assembled on top of each other. Of course, with increased numbers of layers comes increased fabrication cost, yield reduction, and increased difficulty of assembly and electrical interconnection. Also, only about ⅓ of the input electrical energy does useful work. While a polymer actuator structure like that described in Cabuz et al. is demonstrably “better” than the conventional silicon based devices, there is still a desire to further improve polymer actuators.

### BRIEF SUMMARY OF THE INVENTION

The present invention provides a significant improvement over conventional “linear” type cells employed in polymer actuators or MEMS. As is described in detail later herein, by changing the unit cell shape from linear to circular significant performance improvements can be achieved. In particular, a circular unit cell can be designed to virtually any force specification and independently to virtually any displacement specification. The circular unit cell also has a theoretical efficiency of nearly 100%, so that nearly all electrical input energy is converted to useful work.

In accordance with a preferred embodiment of the present invention there is provided a microactuator device comprising at least a pair of polymeric sheets each having conductive and dielectric films deposited thereon, the polymeric sheets facing each other and bonded together to create at least one cell having a substantially circular shape substantially parallel to a plane in which the polymeric sheets lie, the at least one cell having at least one egress hole to allow a fluid to pass there through when a source of electric potential is applied to the conductive films to cause a portion of the polymeric sheets in the vicinity of a perimeter of the cell to be attracted to one another and thereby cause the cell to retract upon itself.

The features and attendant advantages of the present invention will become more apparent to those skilled in the art upon a reading of the following detailed discussion in conjunction with the associated drawings.

### BRIEF DESCRIPTION OF THE DRAWINGS

FIG. 1 is a plan view of circular unit cells in a polymer actuator in accordance with the present invention.

FIG. 2 is a cross sectional view of one of the circular cells in accordance with the present invention.

FIGS. 3A and 3B depict two possible configurations for a circular cell in accordance with the present invention.

FIG. 4 is a graph showing force versus displacement for a linear unit cell from equations 5 and 10.

FIG. 5 is a graph showing displacement versus voltage for a linear unit cell.

FIG. 6A is a graph comparing an analytical model with a finite element model (FEM) of a linear unit cell.

FIG. 6B is a graph comparing displacement versus voltage calculated by the analytical model and FEM of a linear unit cell.

FIG. 7 is a graph showing force versus displacement for a circular unit cell from equations 12 and 17.

### DETAILED DESCRIPTION OF THE INVENTION

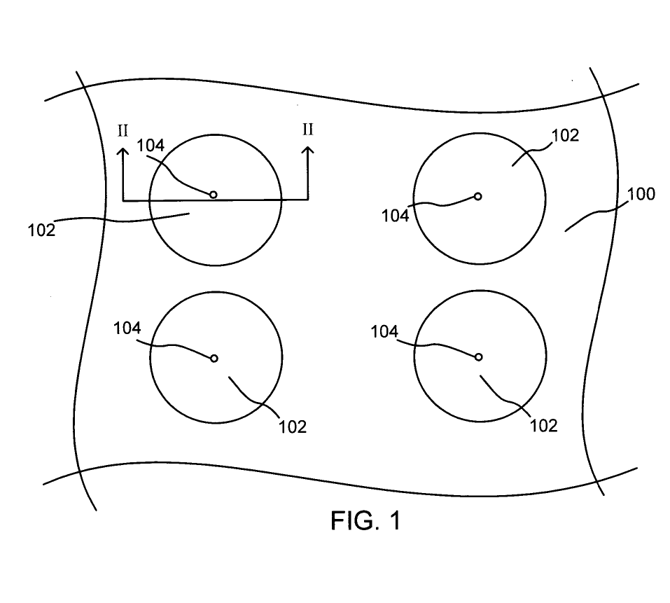

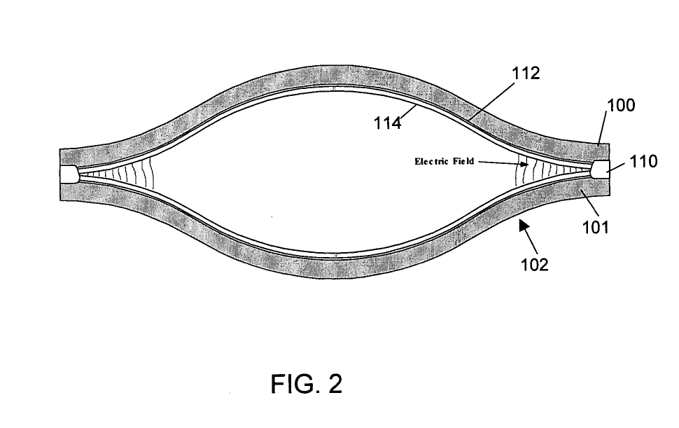

FIG. 1 is a plan view of a polymer actuator in accordance with the present invention. Reference numeral 100 is a top sheet of polymeric material such as KAPTON®, MYLAR® or KALADEX®, like those mentioned in U.S. Pat. No. 6,255,758, which is incorporated herein in its entirety. A bottom sheet 101 (shown in FIG. 2) is preferably made of the same material selected for top sheet 100. In contrast to the linear unit cells of the prior art, the present invention provides circular unit cells 102. While FIG. 1 depicts only four cells, any number of circular unit cells 102 can be provided to accommodate the particular application for which the actuator is employed.

A circular cell is provided by “sweeping” the cross section of a conventional linear unit cell into a circular shape. Consequently, a circular unit cell in accordance with the present invention is fabricated by fusing or adhesively bonding top and bottom sheets 100, 101 around a circumference or perimeter of the cell. In a preferred embodiment, at least one leak (or egress) hole 104 is provided on at least one of the top and bottom sheets 100, 101 to allow air (or another fluid) to flow from inside the cell when power is applied to electrodes causing the cell to retract onto itself. Instead of leak hole 104, a relatively small portion of the perimeter of circular unit cell 102 can be left unfused or unglued to provide the same air (or fluid) egress functionality.

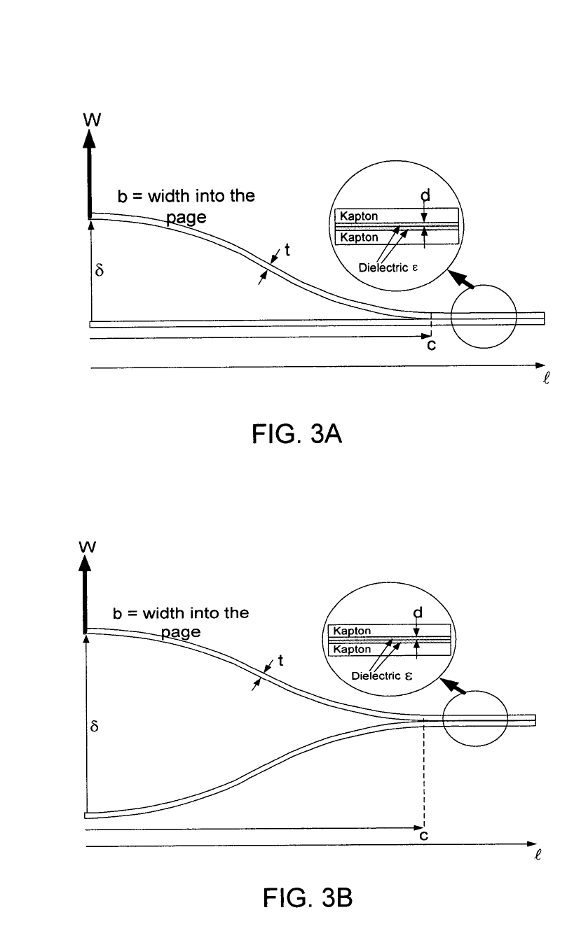

FIG. 2 is a cross sectional view of one of the circular cells 102 in accordance with the present invention and shows the top and bottom sheets 100, 101, adhesive 110 at a perimeter portion of the cell, a metal electrode 112 and a dielectric 114. This type of layer structure is well-known and is described in, for example, U.S. Pat. No. 6,255,758. A more detailed description of the present invention follows with reference to FIGS. 3-7.

Analytical Modeling of a Linear Unit Cell

An analytical model of a linear unit cell is derived first. This is then modified to explore the effects of a circular unit cell shape.

FIGS. 3A and 3B show the parameters used in the analytical model of a linear unit cell. Two basic designs—one with a rigid (flat) centerplane and the other with two bowed sheets—are shown. Only half of the unit cell is shown. The other half is identical, by symmetry. The distance from the center of the cell to the edge is l. When no voltage is applied, the surfaces are separated at all points except the end point at l. The drawings show the cell with a voltage applied, where the contact point has moved to a distance c from the center of the cell. Obviously, c can never be larger than l.

The model uses energy minimization to derive equations for deflection with and without applied voltage, and an equation for the pull-in voltage. The “system,” in this case, is the actuator plus its power source. The total energy of the system has four terms:
1. electrostatic energy, U_{E}, stored in the electric field of the capacitor formed by the metal films;
2. electrical work, U_{P}, done by the power source;
3. bending energy, U_{B}, of the actuator (i.e., the spring energy of the polymer structure);
4. work, W=Fₑₓₜδ, done on the actuator by the external force, Fₑₓₜ, moving the actuator through a distance δ.

The electrostatic field (and therefore the electrostatic energy) drops off very rapidly as the separation between the sheets increases. Simple estimates and finite element models show that the field is negligible when the gap is a little over 1 μm. This occurs over a distance along the x-axis on the order of 10 microns or less, which is small compared to the total length of the cell. Therefore, we can assume, with little loss in accuracy, that the electrostatic energy is zero everywhere the gap is nonzero, and is constant where the gap is zero. The gap is nonzero from the left hand edge (in FIGS. 3A and 3B) to the contact point c, and is zero beyond that. The electrostatic energy, U_{E}, is then simply that of the parallel plate capacitor in the contacted region. The work done by the power source is U_{P}=−QV where Q the amount of charge that has had to move through the potential V. The sign is negative because the potential energy of the source decreases as it charges the capacitor. Since the actuator is a capacitor, Q=CV, and U_{P}=−CV². Therefore,

$${U}_{E} + {U}_{P} = \frac{1}{2} {CV}^{2} - {CV}^{2} = - \frac{{ɛ}_{0} ɛ b ( l - c ) {V}^{2}}{4 d} \qquad ( 1 )$$

The bending energy is derived from the curvature of the sheet. Since the electrostatic force falls off so quickly, it has negligible influence on the profile of the curved sheet. This profile is that of a beam with a load Fₑₓₜ at the end, and can be found in standard texts and reference books on stress and strain in materials. For example, Roark and Young, Formulas for Stress and Strain, gives the profile as

$$y = \frac{{F}_{ext}}{{Ebt}^{3}} {l}^{3} - \frac{3 {F}_{ext} c}{{Ebt}^{3}} {x}^{2} + \frac{2 {F}_{ext}}{{Ebt}^{3}} {x}^{3} .$$

The bending energy is given by

$${U}_{B} = \frac{{Ebt}^{3}}{24} \int {( \frac{{\partial }^{2} y}{\partial {x}^{2}} )}^{2} ⅆ x = \{ \begin{matrix}\frac{1}{2} {k ( \frac{l}{c} )}^{3} {δ}^{2} & c < l \\ \frac{1}{2} k {δ}^{2} & c = l\end{matrix} \qquad ( 2 )$$

where k is the “spring constant” of the bent sheet:

$$k ≡ \frac{{F}_{ext}}{δ} = \frac{{Ebt}^{3}}{{nl}^{3}} \qquad ( 3 )$$

n=1 if the structure has flat centerplanes, as in FIG. 3A, and n=2 if the flat planes are missing, as in FIG. 3B.

The total energy is then

$${U}_{T} = \frac{1}{2} {k}_{A} \frac{{l}^{3}}{{c}^{3}} {δ}^{2} - \frac{{ɛ}_{0} ɛ b ( l - c ) {V}^{2}}{4 d} + {F}_{ext} δ , \qquad ( 4 )$$

First, consider the simple cases when V=0. Equilibrium is found by minimizing the energy with respect to δ.

$$\frac{\partial {U}_{T}}{\partial δ} = {k}_{A} δ + {F}_{ext} = 0 or {F}_{ext} = - {k}_{A} δ , \qquad ( 5 )$$

the standard expression of Hooke's Law for a spring. Note that if V=0, then c=1 since there is no electrostatic force to pull the contact point in.

To solve for the behavior with nonzero voltage, we first need to find the value of c for a given force and voltage. This is done by minimizing the energy with respect to c while holding all other dimensions fixed.

$$\frac{\partial {U}_{T}}{\partial δ} = - \frac{3}{2} {k}_{A} \frac{{l}^{3}}{{c}^{4}} {δ}^{2} + \frac{{ɛ}_{0} ɛ {bV}^{2}}{4 d} = 0 \qquad ( 6 )$$

Solving for c gives

$${c}^{4} = \frac{6 {dk}_{A} {l}^{3} {δ}^{2}}{{ɛ}_{0} ɛ {bV}^{2}} . \qquad ( 7 )$$

Plugging this back in gives the total energy, when c is at equilibrium, as

$${U}_{T} = 2 {( {k}_{A} {l}^{3} )}^{1 / 4} {( \frac{{ɛ}_{0} ɛ {bV}^{2}}{6 d} )}^{3 / 4} {δ}^{1 / 2} - \frac{{ɛ}_{0} ɛ {blV}^{2}}{4 d} + {F}_{ext} δ . \qquad ( 8 )$$

Finally, as in the V=0 case, the equilibrium displacement is found by minimizing the energy with respect to δ.

$$\frac{\partial {U}_{T}}{\partial δ} = {( {k}_{A} {l}^{3} )}^{1 / 4} {( \frac{{ɛ}_{0} ɛ {bV}^{2}}{6 d} )}^{3 / 4} \frac{1}{{δ}^{1 / 2}} - \frac{{ɛ}_{0} ɛ {blV}^{2}}{4 d} + {F}_{ext} = 0 \qquad ( 9 )$$

which rearranges to give an expression relating the external force, the displacement, and the applied voltage.

$${F}_{ext} = - {( \frac{{ɛ}_{0} ɛ b {k}_{A} l}{6 d} )}^{3 / 4} \frac{{V}^{3 / 2}}{{( {k}_{A} δ )}^{1 / 2}} . \qquad ( 10 )$$

The right hand side of (10) is the combined electromechanical force, Fₑₘ, produced by the actuator at displacement d and voltage V. The negative sign indicates the direction of the force (i.e., opposite to the direction of the external force). The sign can be dropped if we are just considering the magnitude of the force. Note that this expression is valid only for c<l. If c=l, there is no surface length in contact, and the electrostatic energy term is identically zero. Therefore, for c=l the purely mechanical equation (5) is the correct expression.

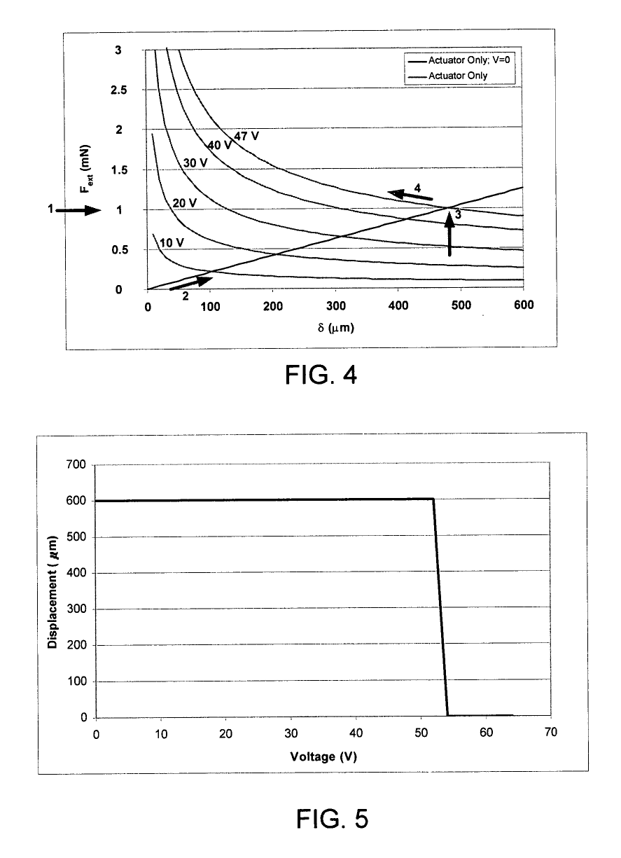

To see that this results in a pull-in behavior, compare the two lines in FIG. 4. Initially, with no external force applied and no voltage, the actuator has zero displacement. For illustration, suppose a 1 mN force is applied (arrow #1). With the voltage still off, the actuator behaves like a spring, and displacement travels up the line (arrow #2) until it reaches arrow #3, the displacement at 1 mN force (˜485 μm). The curves represent the combined electromechanical behavior when various voltages are applied. The electromechanical force generated by the actuator at 10 V (the bottom curve) at 485 μm is small compared to the external force and the spring-like (i.e., mechanical only) actuator force. Therefore, the actuator still behaves like a spring, and the displacement does not move from position 3. The same is true at 20 V, 30 V, and 40 V. When the voltage reaches 47 V, the electromechanical curve intersects the mechanical curve at 485 μm, causing the displacement to begin to get smaller (along arrow #4). As it does, the electromechanical force increases even more, pulling the displacement in faster and faster until the actuator is fully closed. The deflection as a function of voltage, showing the classic pull-in behavior, is plotted in FIG. 5. The deflection is approximately constant, and c=l, for V less than some threshold, or pull-in, voltage.

The pull-in voltage, V_{PI}, is therefore the voltage at which equation (5), the purely mechanical response, equals equation (10), the combined electromechanical response. This yields

$${V}_{PI} = {( \frac{6 d}{{ɛ}_{0} ɛ b {k}_{A} l} )}^{1 / 2} {F}_{ext} \qquad ( 11 )$$

Comparison with FEM

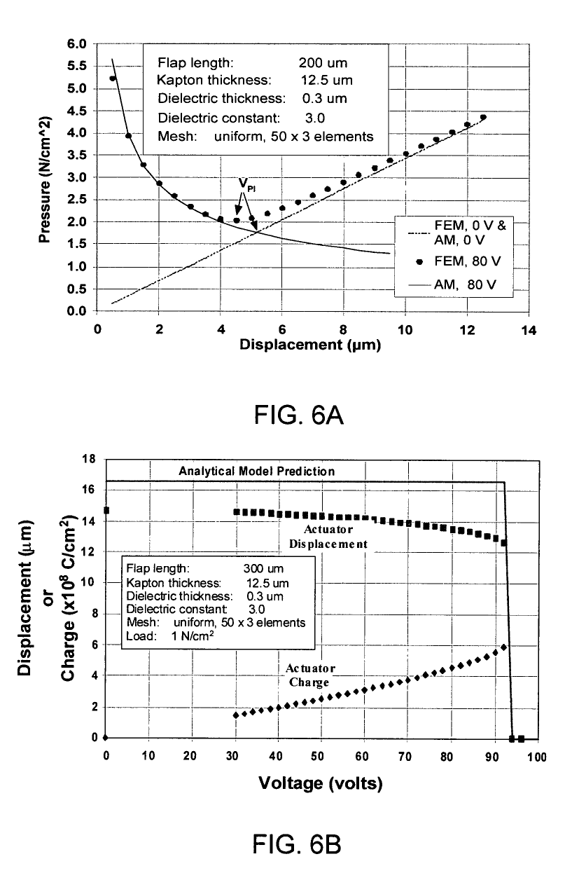

FIG. 6A is a comparison of the analytical model with the finite element model. This graph should be interpreted the same as FIG. 4. The dots represent FEM results while the lines are from the analytical model. The excellent agreement is obvious. FIG. 6B compares displacement versus voltage calculated by the analytical model and FEM, also showing a good match. The analytical model tends to overestimate the displacement and the pull-in voltage by a small amount, typically no more than 10-15%.

Analytical Modeling of a Circular Unit Cell

In accordance with the present invention, the unit cell can be a circle, or even a square, with the sheets bonded together all around the perimeter. Leak holes are preferably placed in this type of cell to allow air to flow in and out as the cell opens and closes. Since there is more length with zero gap, this cell is believed to be stronger. The model is derived the same as before, with the bending and electrostatic terms modified to account for the new geometry. FIG. 3B can still be used to describe the cell, but now the profile is swept into a circle of radius l rather than extruded into the page. A small length, r₀, is defined as an area over which the external force is applied. The deflection profile for a circular plate unit cell (two individual plates) is given by (again from the Roark and Young reference)

$$δ = 2 z = - \frac{3 {F}_{ext} ( 1 - {v}^{2} )}{2 π E {t}^{3}} [ {l}^{2} - {r}^{2} ( 1 + 2 ln ( \frac{l}{r} ) ) ] \qquad ( 12 )$$

The bending energy for a single plate is

$$d {U}_{B} = \frac{E {t}^{3}}{24 ( 1 - {v}^{2} )} [ {( \frac{{\partial }^{2} z}{\partial {r}^{2}} + \frac{1}{r} \frac{\partial z}{\partial r} )}^{2} + 2 ( 1 - v ) ( \frac{1}{r} \frac{\partial z}{\partial r} \frac{{\partial }^{2} z}{\partial {r}^{2}} ) ] 2 π r dr \qquad ( 13 )$$

Calculating the derivatives from Eq. (12), plugging into Eq. (13) and integrating from r₀ to l yields the total bending energy:

$${U}_{B} = \frac{π}{3} \frac{{Et}^{3}}{( 1 - {v}^{2} )} \frac{\{ {c}^{2} - {r}_{o}^{2} - ( 6 - 2 v ) {{r}_{o}^{2} ( ln \frac{{r}_{o}}{c} )}^{2} \}}{{\{ {c}^{2} - {r}^{2} ( 1 + 2 ln \frac{c}{r} ) \}}^{2}} {δ}^{2}$$

Assuming r₀<<c, and replacing l with the variable parameter c, this simplifies to a more manageable form

$${U}_{B} \approx \frac{π}{3} \frac{{Et}^{3}}{( 1 - {v}^{2} ) {c}^{2}} {δ}^{2} \qquad ( 14 )$$

The electrostatic energy is based on the same assumptions as the basic model. For the circular geometry, this becomes

$${U}_{E} + {U}_{P} = - \frac{{ɛ}_{o} ɛ π ( {l}^{2} - {c}^{2} )}{4 d} {V}^{2} \qquad ( 15 )$$

so that

$${U}_{T} = \frac{π}{3} \frac{{Et}^{3}}{( 1 - {v}^{2} ) {c}^{2}} {δ}^{2} - \frac{{ɛ}_{o} ɛ π ( {l}^{2} - {c}^{2} )}{4 d} {V}^{2} + {F}_{ext} δ . \qquad ( 16 )$$

Following the same procedure as before, we take the derivative with respect to c, solve for c, plug that value back into the total energy, and finally set ∂U_{T}/∂δ=0, with the result

$${F}_{ext} = - \frac{π \sqrt{3}}{4} {( \frac{{Et}^{3}}{( 1 - {v}^{2} )} \frac{{ɛ}_{o} ɛ}{4 d} )}^{1 / 2} V . \qquad ( 17 )$$

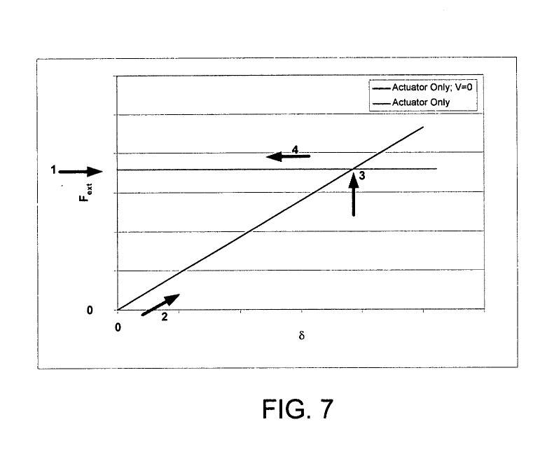

This is analogous to the linear unit cell model equation (10), and is valid for c<l. The interesting feature of equation (17) is that there is no dependence on δ. FIG. 7 shows the force-displacement graph for the circular cell, analogous to FIG. 4 for the linear cell. When the external force is applied, the cell opens up to some displacement. As the voltage is turned on and increased a combined electromechanical response is generated which is flat as a function of δ. Initially, the electromechanical force is less than the external force, and nothing happens. However, when the voltage is large enough, the actuator pulls in. The circular unit cell pull-in is different than the linear unit cell pull-in, however. In the model of the linear unit cell, as the cell pulled in slightly, the electromechanical force got even larger, producing a runaway pull-in. In the circular unit cell, the electromechanical and external forces are equal, resulting in no pull-in until the voltage just exceeds V_{PI}. Pull-in occurs, but it is not a runaway pull-in. Another way to express this is that in the linear model, kinetic energy is produced and increases as the cell pulls in. In the circular model, the cell pulls in at a constant velocity, and there is no increase in kinetic energy. This phenomenon has consequences when we consider power consumption later herein. The pull-in voltage comes from rearranging eq. (17)

$${V}_{PI} = \frac{4}{π \sqrt{3}} {( \frac{( 1 - {v}^{2} )}{{Et}^{3}} \frac{4 d}{{ɛ}_{o} ɛ} )}^{1 / 2} {F}_{ext} . \qquad ( 18 )$$

There are two very important consequences with respect to a circular unit cell. The first is that the force generated by a single cell of the actuator is independent of the displacement. This is very different from the linear unit cell where force varied as δ^{1/2} (see eq. 10). To generate a large force with the linear cell, one has to settle for a reduced displacement. To get large displacements, many layers of unit cells must be stacked on top of each other. This requires fabrication of many cells, some form of assembly procedure, and a means of electrically connecting to all of those layers. In contrast, the circular cell can be designed to achieve substantially any force and substantially any displacement. Force is controlled most easily by controlling the thickness (eq. 17 and 18) and displacement can be independently controlled by controlling the unit cell diameter (eq. 12). Thus, a single layer of circular unit cells (or at most a small number of layers) can be designed to do the job of many layers of linear unit cells. This greatly reduces the complexity and cost of fabrication and assembly, and improves yield.

The second consequence is that the power consumption of a circular unit cell is a minimum. The argument for this comes from the fact that the force generated by the cell is constant as it pulls in. No kinetic energy is created and, therefore, no energy is lost when motion stops at the end of the pull-in. Thus, all of the electrical energy goes in to useful work and none is wasted. Theoretically, the efficiency of this cell is nearly 100%. In reality, of course, there are losses, etc. that reduce the efficiency, but no unit cell design can be more efficient. In addition to the high efficiency, the design flexibility described in the previous paragraph also contributes to a significant energy savings. As described above, a circular-cell actuator can be constructed from a smaller number of layers than a linear-cell actuator. Since the total capacitance of the actuator is approximately proportional to the number of layers, the circular-cell actuator has a lower total capacitance. This reduces the energy required to charge the capacitor and the energy lost when discharging the capacitor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, the circular cells described herein need not be precisely circular, but are preferably substantially circular to achieve the performance described. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A microactuator device, comprising:
at least a pair of polymeric sheets each having conductive and dielectric films deposited thereon, the polymeric sheets facing each other and bonded together to create at least one cell having a substantially circular shape parallel to a plane in which the polymeric sheets lie, the at least one cell having at least one egress hole to allow a fluid to pass there through when a source of electric potential is applied to the conductive films to cause a portion of the polymeric sheets in the vicinity of a perimeter of the cell to be attracted to one another and thereby cause the cell to retract.

2. The microactuator device of claim 1, comprising a plurality of cells.

3. The microactuator device of claim 2, comprising a plurality of pairs of polymeric sheets laminated to each other to form a stack.

4. The microactuator device of claim 1, wherein one of the pair of polymeric sheets is substantially flat.

5. The microactuator device of claim 1, wherein each one of the pair of polymeric sheets is bowed.

6. The microactuator device of claim 1, further comprising adhesive for bonding the polymeric sheets.

7. An electrostatic microactuator, comprising:
a plurality of substantially circular cells arranged in a predetermined pattern and obtained by bonding sheets of polymeric material together with substantially circular patterns;
at least one fluid egress passage provided in each of the cells;
the sheets of polymeric material including conductive and dielectric films disposed thereon such that when a source of electric potential is applied to the conductive films the polymeric sheets in the vicinity of a perimeter of each of the cells are attracted to one another to cause the cells to contract.

8. The microactuator device of claim 7, comprising a plurality of pairs of polymeric sheets laminated to each other to form a stack.

9. The microactuator device of claim 7, wherein one of the polymeric sheets is substantially flat.

10. The microactuator device of claim 7, wherein a portion of each of the polymeric sheets associated with a given cell is bowed.

11. The microactuator device of claim 7, further comprising adhesive for bonding the polymeric sheets.

12. An electrostatic microactuator, comprising:
a first polymeric sheet having a conductive film and a dielectric film disposed thereon;
a second polymeric sheet having a conductive film and a dielectric film disposed thereon; and
an adhesive disposed and patterned between the sheets to provide a plurality of substantially circular cells, wherein each of the cells includes a fluid egress hole,
wherein the cells are operable to contract as a result of an electrostatic force created upon application of an electrical potential to the respective conductive films of the first and second polymeric sheets.

13. The electrostatic microactuator of claim 12, comprising a plurality of pairs of polymeric sheets laminated to each other to form a stack.

14. The electrostatic microactuator of claim 12, wherein one of the polymeric sheets is substantially flat in the vicinity of a given cell.

15. The electrostatic microactuator of claim 12, wherein a portion of each of the polymeric sheets associated with a given cell is bowed.

16. A microactuator device that minimizes energy loss, comprising a plurality of electrostatically controllable cells disposed adjacent one another, at least one of the cells having a substantially circular shape, wherein the at least one of the cells exhibits a substantial constant velocity pull in after a threshold pull in voltage is applied to opposing surfaces of the at least one cell.

17. The microactuator device of claim 17, wherein the device is comprised of a pair of polymeric sheets.

18. The microactuator device of claim 17, comprising a plurality of layers of cells.

19. A microactuator device that minimizes energy loss, comprising a plurality of electrostatically controllable cells disposed adjacent one another, at least one of the cells having a substantially circular shape, wherein a force generated by the at least one of the cells, after a threshold pull in voltage is applied to opposing surfaces of the at least one cell, is independent of displacement.

20. The microactuator device of claim 19, wherein the device is comprised of a pair of polymeric sheets.

21. The microactuator device of claim 19, comprising a plurality of layers of cells.
